(19) United States
(12) Patent Application Publication
(10) Pub. No.: US 2025/0219518 A1
(43) Pub. Date: Jul. 3, 2025

(54) ELECTRIC GENERATOR WITH REDUCED INPUT POWER

(71) Applicant: ZSPH3 LLC, Saint Charles, MO (US)

(72) Inventor: Daniel J. Goldkamp, Saint Charles, MO (US)

(21) Appl. No.: 19/008,526

(22) Filed: Jan. 2, 2025

Related U.S. Application Data
(60) Provisional application No. 63/616,950, filed on Jan. 2, 2024.

(51) Int. Cl. H02K 21/28

(52) U.S. Cl. CPC H02K 21/28

(57) ABSTRACT

An electric generator is disclosed that utilizes a rotor with a plurality of inductive rotor teeth interacting with a stator comprising magnets arranged in alternating polarity. The generator induces alternating magnetic polarity in the rotor teeth as they pass the magnets, generating electrical energy while minimizing input torque requirements. Configurations include fixed and rotating aluminum cylinder assemblies, each embedded with magnets and geared to operate synchronously with the rotor, enhancing efficiency. Methods for optimizing energy output include redirecting opposing magnetic forces perpendicular to the input torque and maintaining optimal spacing between rotor teeth and magnets. Simulations demonstrate a significant reduction in input energy while maintaining comparable power generation to conventional systems. The disclosed generator provides improved energy efficiency for various applications.

### CROSS-REFERENCE TO RELATED APPLICATIONS

This application claims the benefit of U.S. Provisional Application No. 63/616,950, filed on Jan. 2, 2024, the entirety of which is incorporated herein by reference.

### TECHNICAL FIELD OF THE PRESENT DISCLOSURE

The present disclosure relates to electric generators and their operation. In particular, the present disclosure relates to electric generators requiring a reduced amount of input power for operation.

### BACKGROUND OF THE PRESENT DISCLOSURE

Electric generators are often used to generate and provide power in circumstances and places where electricity is otherwise needed and unavailable for one or more reasons. Electric generators play a pivotal role in converting mechanical energy into electrical energy for various industrial, residential, and renewable energy applications. Traditional generator designs often face challenges such as high input torque requirements, inefficiencies in energy conversion, and mechanical wear due to resistance forces. As global energy demands increase, there is a growing need for generators that can deliver consistent energy output with improved efficiency and reduced operational costs. Furthermore, the integration of sustainable energy sources, such as wind and water turbines, necessitates generators that can adapt to fluctuating input conditions while maintaining reliable performance.

Advances in electromagnetic principles, material science, and mechanical engineering have opened opportunities for enhancing generator designs. These improvements focus on optimizing magnetic interactions, reducing energy losses, and minimizing physical wear. Despite these advancements, achieving a balance between high energy output and low input torque remains a critical area of innovation. Addressing these challenges is essential for developing generators that are versatile, efficient, and suitable for diverse energy needs.

### SUMMARY OF THE DISCLOSURE

This document discloses an advanced electric generator design that leverages inductive rotor teeth and alternating polarity magnets to optimize energy conversion. The generator includes a rotor with multiple inductive teeth and a stator featuring precisely aligned magnets, which interact dynamically to produce a time-varying voltage output. Key innovations include the use of soft magnetic metals, optimized spacing between components, and the redirection of opposing magnetic forces to reduce input torque requirements. These features collectively enhance the generator's efficiency and reliability.

Additional enhancements include aluminum cylinders with embedded magnets that rotate synchronously with the rotor, minimizing drag and maximizing magnetic field stability. A precision gear mechanism ensures synchronized operation, while slip rings enable real-time performance monitoring. The system is adaptable to various energy applications, from small-scale residential setups to large industrial installations, and supports integration with renewable energy systems. Simulations and real-world tests validate the generator's ability to deliver consistent energy output with reduced mechanical resistance.

The disclosed generator represents a significant advancement in energy generation technology, offering improved performance, scalability, and operational efficiency. Its innovative design addresses longstanding challenges in generator efficiency and adaptability, making it a practical solution for modern energy demands.

The present disclosure provides an electric generator which requires a reduced input power for operation in comparison to conventional electric generators.

### BRIEF DESCRIPTION OF THE DRAWINGS

The detailed description of the drawings particularly refers to the accompanying figures in which:

FIG. 1 illustrates an exemplary electric generator;

FIG. 2 illustrates a schematic showing the workings of an exemplary generator;

FIG. 3 illustrates an exemplary model showing the energy required to move an inductor relative to the distance from the center of a given magnet;

FIG. 4 illustrates exemplary directions that force may be directed in when approaching on the path of an arc;

FIG. 5 illustrates a graphical representation of the difference between the energy required to rotate a rotor of the exemplary generator of FIGS. 1-3 and a secondary exemplary generator with an alternative force direction illustrated in FIG. 4;

FIG. 6 illustrates an exemplary schematic configuration of a generator;

FIG. 7 illustrates a first simulation of the exemplary schematic configuration of FIG. 6 in which outer aluminum cylinders of the configuration are in a fixed position;

FIG. 8 illustrates a second simulation of the exemplary schematic configuration of FIG. 6 in which the outer aluminum cylinders of the configuration are in a rotatable position;

FIG. 9 illustrates the torque measurements for each of the fixed aluminum cylinder configuration of FIG. 7 and the rotating aluminum cylinder configuration of FIG. 8;

FIG. 10 illustrates the magnetic energy output for each of the fixed aluminum cylinder configuration of FIG. 7 and the rotating aluminum cylinder configuration of FIG. 8;

FIG. 11 illustrates the torque to magnetic energy ratio for each of the fixed aluminum cylinder configuration of FIG. 7 and the rotating aluminum cylinder configuration of FIG. 8;

FIG. 12 illustrates a model of the rotating aluminum cylinder configuration of FIG. 8;

FIG. 13 illustrates an oscilloscope display positioned at the electrical output of the model of FIG. 12;

FIG. 14 illustrates a schematic model implementing the principles of the rotating aluminum cylinder configuration of FIG. 8 on a larger scale;

FIG. 15 illustrates the torque requirements of a model conventional generator compared with the torque requirements of the schematic model of FIG. 14 using a first FEA software;

FIG. 16 illustrates the torque requirements of a model conventional generator compared with the torque requirements of the schematic model of FIG. 14 using a second FEA software; and

FIG. 17 illustrates an exemplary single rotor tooth.

Although the drawings represent embodiments of various features and components according to the present disclosure, the exemplification set out herein illustrates an embodiment, and such an exemplification is not to be construed as limiting the scope of the disclosure in any manner.

### DETAILED DESCRIPTION OF THE DRAWINGS

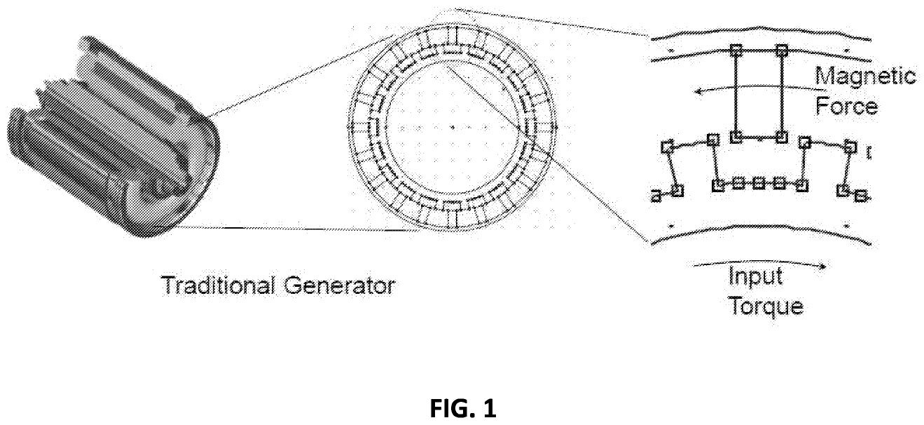

Referring to FIG. 1, an exemplary electric generator is provided. As shown, each wire wound tooth of an electric generator acts as an inductor if it is subject to a changing external magnetic field. A continuous changing of the magnetic field polarity will cause the inductor to create a time varying voltage output. By spinning the rotor inside a series of magnets that alternate polarity with every other magnet, the rotor tooth is subject to a constantly changing magnetic field. As the rotor tooth passes a magnet, it takes on the polarity of said magnet. As such, the rotor tooth varies in polarity. Input power is required to rotate the inductor/rotor, and the amount of power required is relative to the interacting electrical and magnetic fields. As discussed further herein, in conventional generators, a greater power output generally equates to stronger magnetic fields and therefore a greater amount of input torque to maintain motion of the generator.

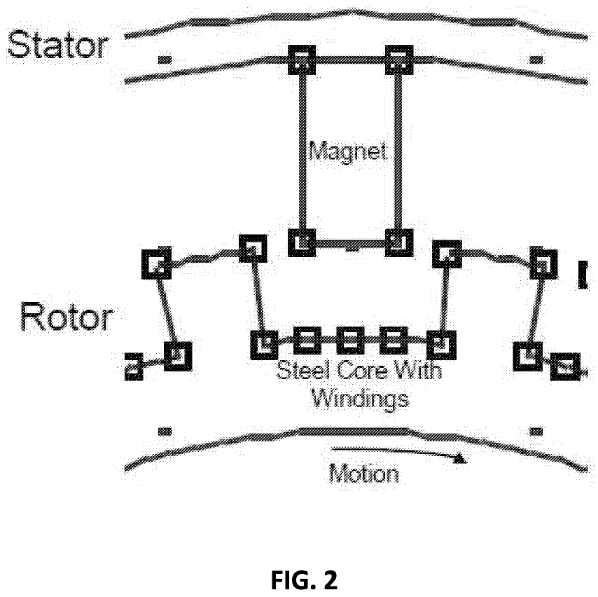

Now referring to FIG. 2, a schematic illustrating the workings of an exemplary generator is provided. As mentioned above, the rotor tooth takes on the same polarity of a magnet as it passes said magnet. Since it is spinning, the rotor tooth will next encounter a subsequent magnet of opposite polarity. As such, the rotor tooth changes polarity again to match that of the subsequent magnet. The rotor tooth may be comprised of magnetic metal and wire. Magnetic metal exhibits resistance in changing polarities. As such, each change in polarity meets resistance. Between forcing the rotor tooth to change polarity and then forcing the two similarly polarized pieces, the rotor tooth and the magnet, apart again through the spinning motion of the rotor requires a powerful input force to facilitate spinning of the generator. As the number of teeth of the rotor increases, the required input force also increases. The distance between each magnet and the rotor tooth as the rotor tooth passes the magnet also makes a difference. Magnetic field strength varies as I over the distance squared between the magnet and the rotor tooth. As such, the closer the magnet gets to the rotor tooth, the strength increases exponentially.

Still referring to FIG. 2, the illustrated schematic example includes a stator having a single permanent magnet with a fixed polarity. Although not shown, an additional magnet is provided on each side of the illustrated single permanent magnet with a polarity opposite of the illustrated single permanent magnet, each followed by another magnet with a polarity opposite of the magnet which it follows, and so on around a portion or a whole of the perimeter of the generator. Each tooth of the rotor is wrapped with a wire (not shown) so that each rotor is an inductor. As the rotor tooth spins, it will encounter each magnet and change polarity, causing said rotor tooth to alternate magnetic polarity with each magnet it encounters. Because the polarity of the inductor/rotor tooth is opposite of the polarity of the magnet it is approaching, they will naturally try to repel each other until the magnet and the inductor/rotor tooth are aligned at the center and the magnet overpowers the inductor/rotor tooth, forcing the polarity to reverse and match that of the magnet. In order for the generator to continue rotating, the input torque must be greater than the magnetic force, as the input torque and the magnetic force are vector forces in opposite directions. As a result, as the magnetic force gains strength, a proportionately larger input torque is required.

Once the polarity of the magnet and the polarity of the inductor/rotor tooth are aligned, they are attracted to each other so that the inductor/rotor tooth faces resistance as it continues to spin and create distance between the magnet and the rotor tooth/inductor. The magnetic attraction is reduced at a rate of 1 over the distance squared as the rotor tooth spins away from the magnet. Like above, in order for the generator to continue rotating, the input torque must be greater than the magnetic force. So, as the magnetic force gains strength, a proportionately larger input torque is required.

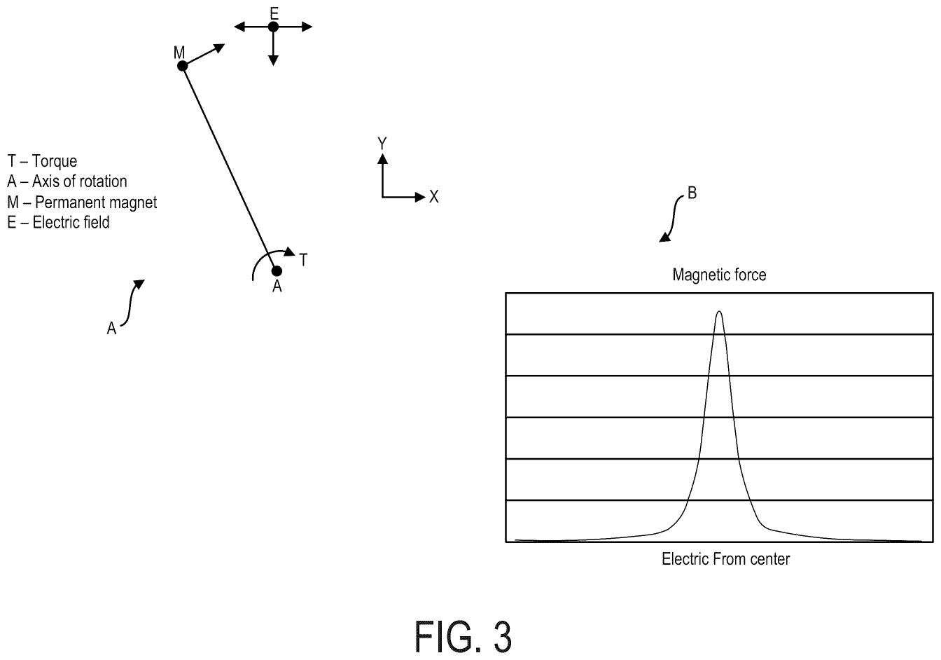

Now referring to FIG. 3, an exemplary model is provided to illustrate the energy required to move the inductor relative to the distance from the center of a given magnet. In model A, torque (T) is directly proportional to length of the rotating arm (rotating about axis (A)) times the opposing force. As the permanent magnet (M) approaches the electric field (E), mechanical energy directed in the “X” direction opposes input torque. As illustrated in graph B and described above, the closer the inductor gets to the magnetic field, the amount of energy (along the y axis) required to move the inductor increases exponentially. In an embodiment of the present disclosure, the amount of force required to spin the inductor within the magnetic field is reduced while the amount of electrical energy generated is maintained, as described further herein. This is achieved by redirecting the force into an angle perpendicular to the input torque so that the force is acting on the mechanical support of the rotor tooth and not against the input torque direction.

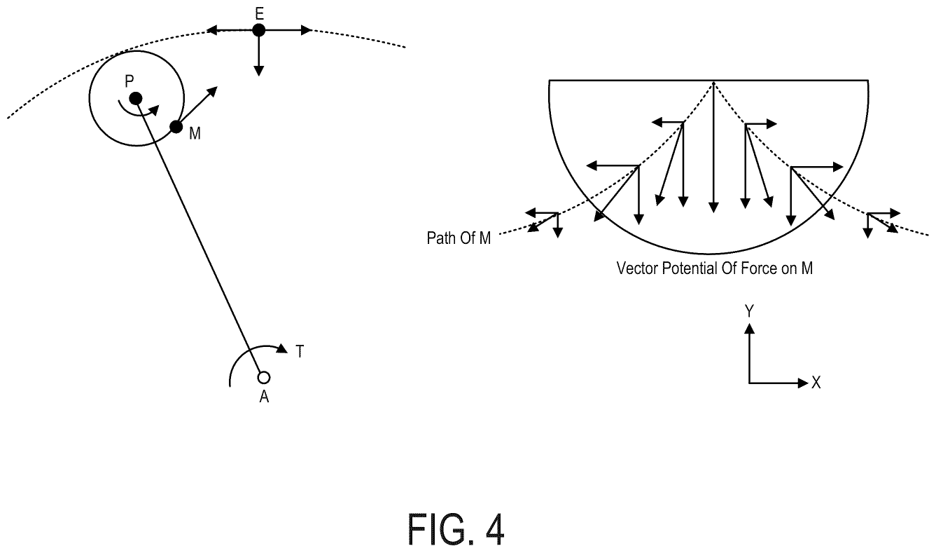

FIG. 4 illustrates, for example, directing the force of one of the magnetically opposed components—either the fixed magnet or the rotor tooth/inductor—onto a path where it would be approaching the other surface on the path of an arc. This takes advantage of pushing some of the energy required to spin the rotor into the “y” direction while also taking advantage of the magnetic field strength getting exponentially stronger as the two surfaces approach each other when nearly all of the opposing energy is directed in the “y” direction. While this is one possible implementation, other implementations may be considered.

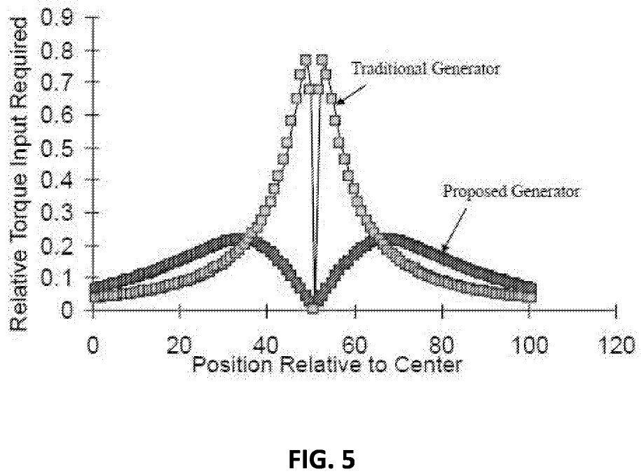

FIG. 5 provides a graphical representation of the difference between the energy required to rotate the rotor in the initial example of FIGS. 1-3 and the secondary example with the alternative force direction described in relation to FIG. 4. As shown, the alternative force direction has a significant reduction in required input energy over the initial example of FIGS. 1-3.

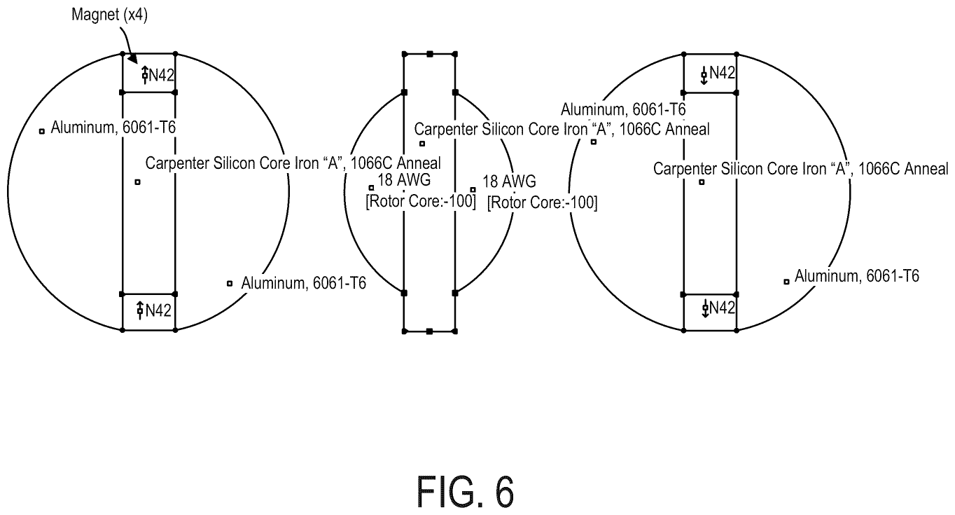

An exemplary schematic configuration is provided in FIG. 6. The illustrated configuration is illustrated as designed within a Finite Element Analysis (FEA) program known as FEMM 4.2, which facilitates simulations of the configurations and is capable of calculating parameters such as torque requirements and magnetic field energies. As illustrated, the model includes three components. In the center is a magnetic core wrapped with wire acting as the rotor. On each side of the magnetic core is an aluminum cylinder including embedded magnets separated by an iron core.

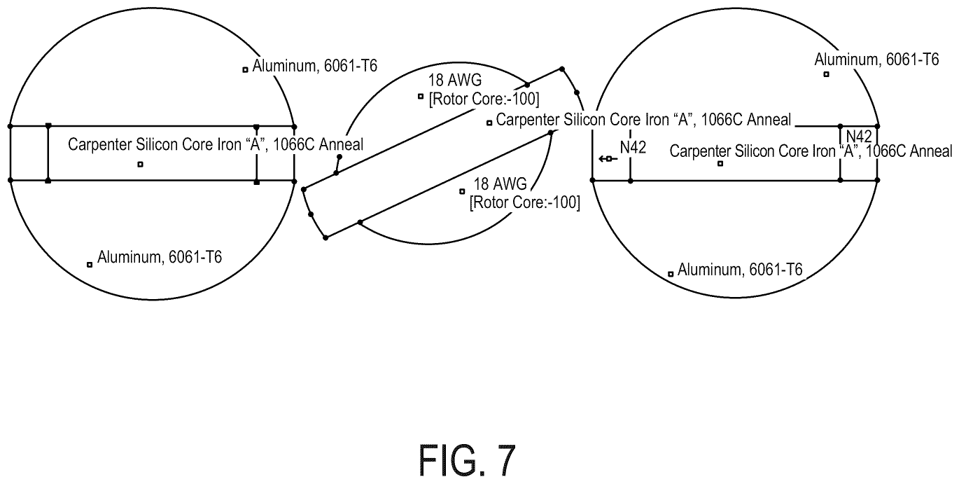

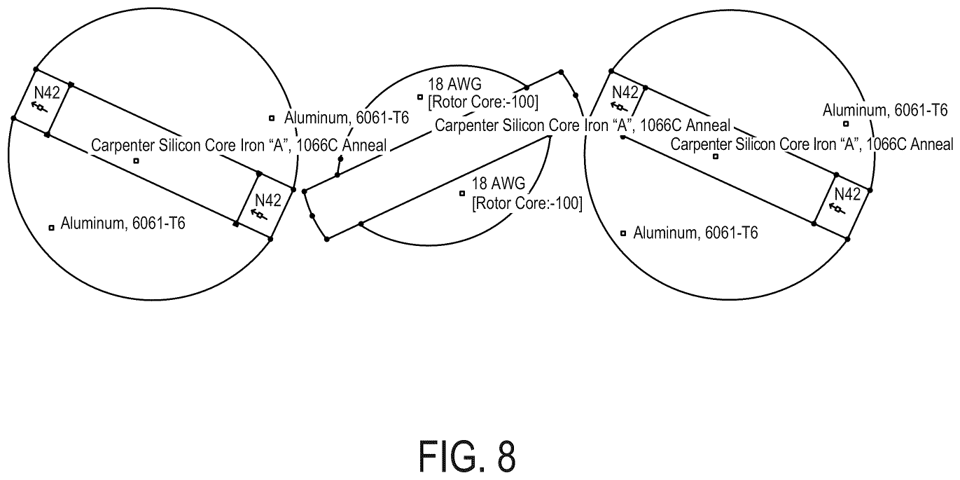

FIG. 7 provides a first simulation of the configuration of FIG. 6 in which the outer aluminum cylinders are fixed in position while the center rotor is rotated past the two fixed magnets. This is similar to that of a generator described above in FIGS. 1-3. FIG. 8 provides a second simulation of the configuration of FIG. 6 in which the outer aluminum cylinders rotate in synchronization with the center rotor, but in an opposite direction of the center rotor. Each of the components may include a large gear (not shown) which mesh the components together to spin each of the three components in tandem at a 1:1 ratio. This configuration is similar to that described above in relation to FIG. 4.

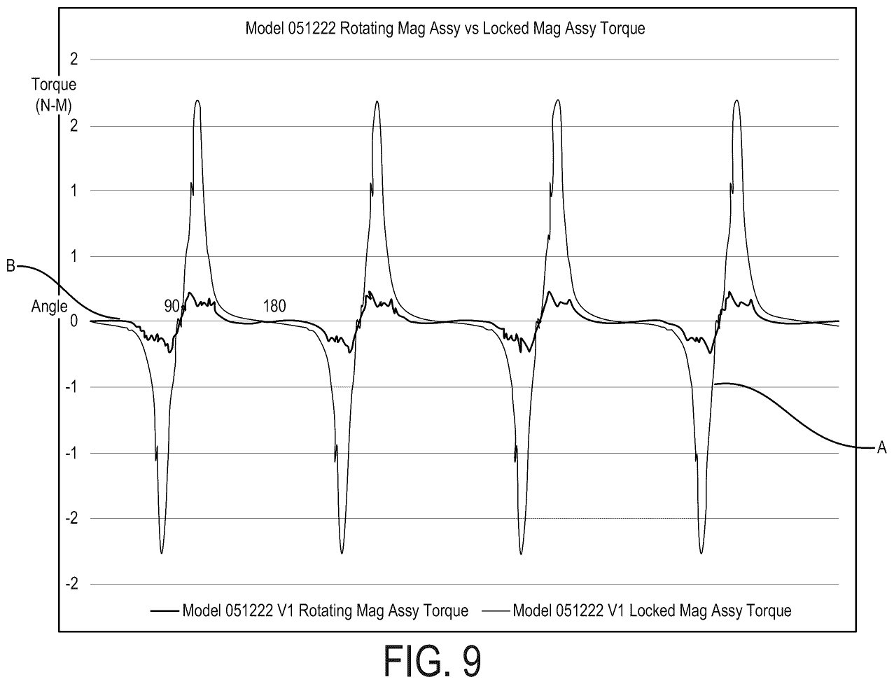

FIG. 9 provides the torque measurements for each of the fixed aluminum cylinder configuration (FIG. 7) illustrated by line A and the rotating aluminum cylinder configuration (FIG. 8) illustrated by line B. The graphed torque measurements support the results provided in FIG. 5 suggesting that the rotating aluminum cylinder configuration may result in a reduced input force requirement as compared to the fixed aluminum cylinder configuration.

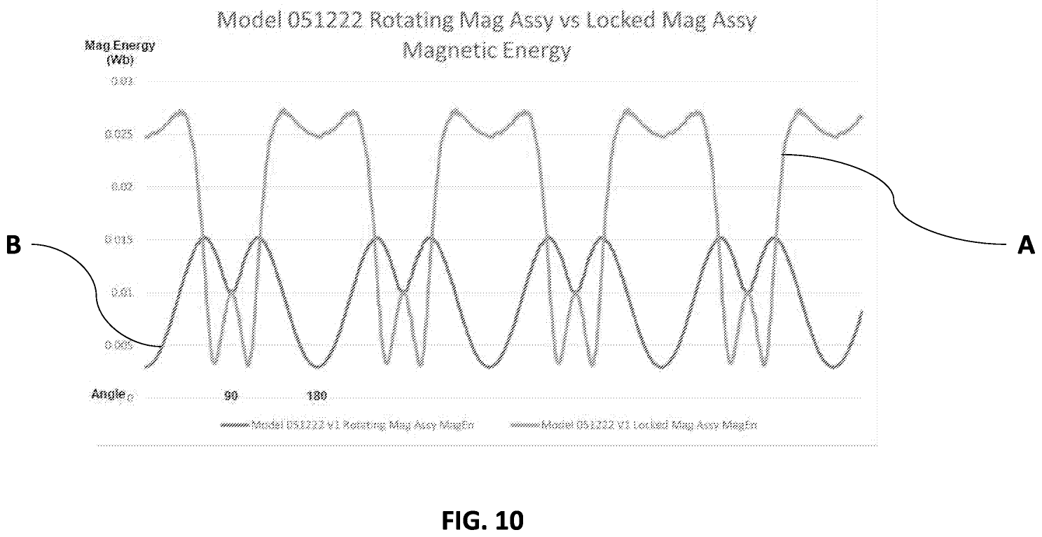

FIG. 10 provides the magnetic energy output for each of the fixed aluminum cylinder configuration (FIG. 7) illustrated by line A and the rotating aluminum cylinder configuration (FIG. 8) illustrated by line B. The graphed measurements support the findings that the generated power is similar between the rotating aluminum cylinder configuration and the fixed aluminum cylinder configuration.

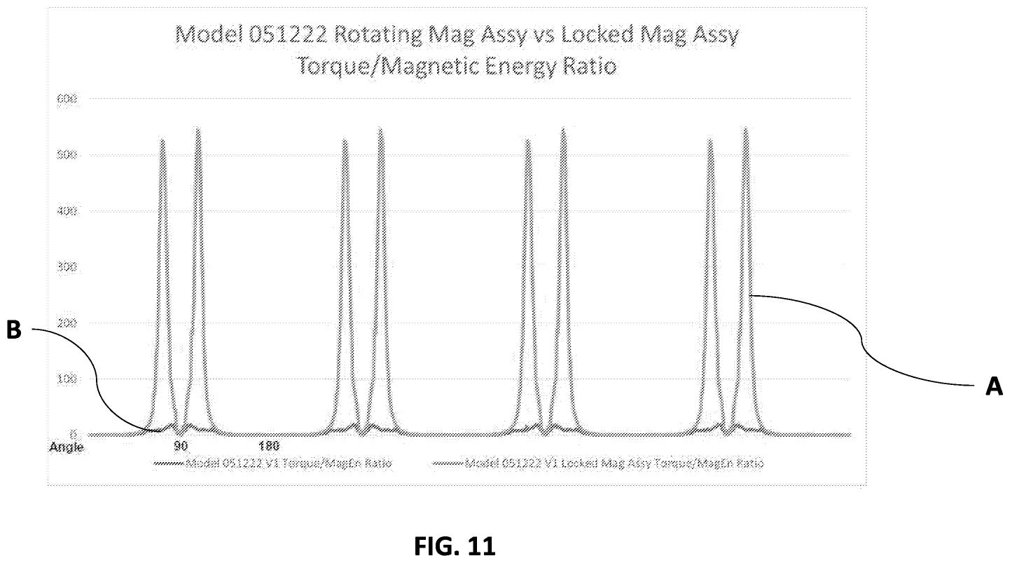

FIG. 11 provides the torque to magnetic energy ratio for each of the fixed aluminum cylinder configuration (FIG. 7) illustrated by line A and the rotating aluminum cylinder configuration (FIG. 8) illustrated by line B. This illustrates that while the graph (FIG. 10) of the generated power alone illustrates that the fixed aluminum cylinder configuration (FIG. 7) and the rotating aluminum cylinder configuration (FIG. 8) have a similar, but not equal, power generation, the total sum amount of usable power generated by the rotating aluminum cylinder configuration is closer to the total sum amount of usable power generated by the fixed aluminum cylinder configuration than it appears from FIG. 10, as the amount of input power needed to achieve the output of the fixed aluminum cylinder configuration is significantly higher than that needed for the rotating aluminum cylinder configuration. That is, the rotating aluminum cylinder configuration is much more efficient than the fixed aluminum cylinder configuration.

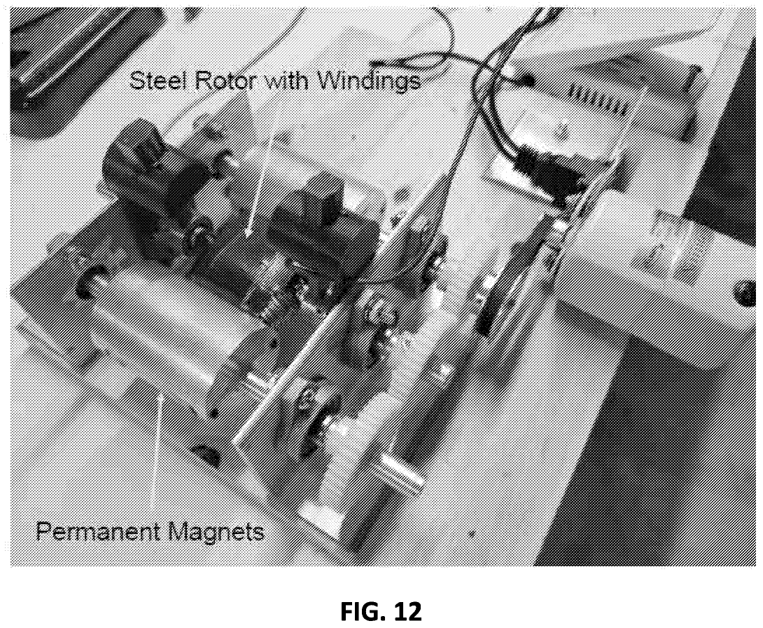

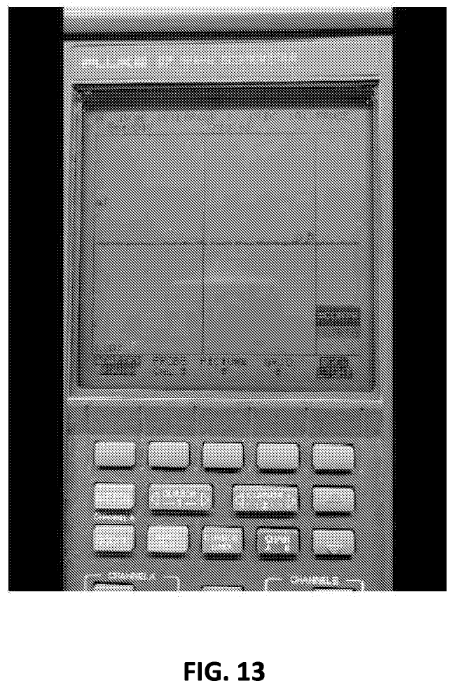

FIG. 12 provides a model of the rotating aluminum cylinder configuration of FIG. 8. Two aluminum cylinders with embedded magnets are located on either side of the rotor in the center. The rotor is comprised of soft magnetic metal wrapped with magnet wire, generally obscured by tape in FIG. 12, which is wrapped over the windings of the magnet wire to keep them in place during operation. In the illustrated model, there are slip rings on each end of the center rotor to allow measurement of electrical activity. The center rotor and the two aluminum cylinders are geared together at a ratio of 1:1 and powered by a small motor. An oscilloscope display (FIG. 13) may be positioned at the electrical output of the device.

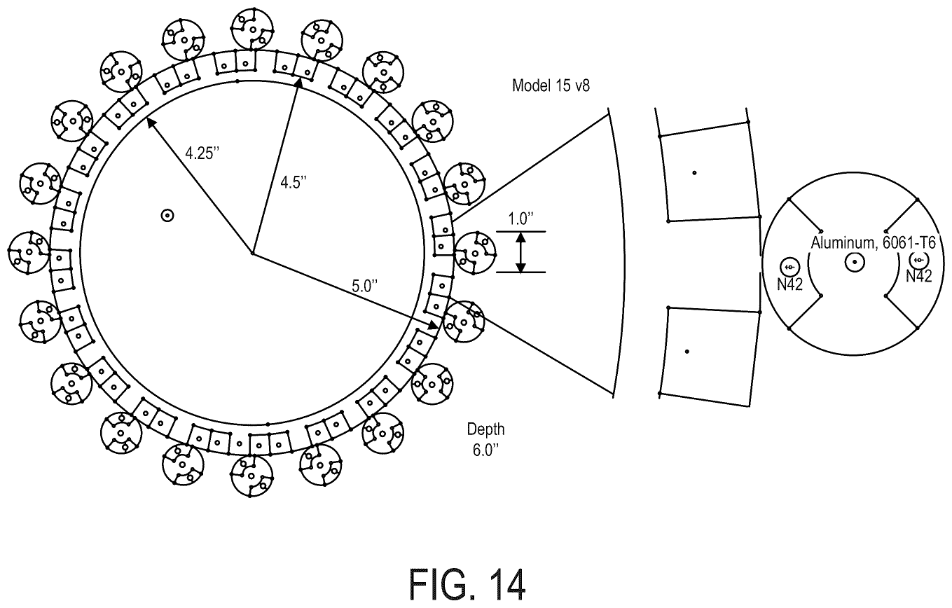

The models illustrated in FIG. 7 and FIG. 8 provide a general idea of the fixed and rotating aluminum cylinder configurations, respectively, and their operations. Now referring to FIG. 14, a schematic model implementing the principles of the rotating aluminum cylinder configuration on a larger scale is illustrated. As shown, a central rotor is surrounded by twenty spinning magnet assemblies. The magnet assemblies each spin at a rate of 10:1 faster than the central rotor such that the magnet surfaces would always be in contact with the rotor and the magnets would align with the rotor teeth as they pass. While this is one possible configuration for implementing the principles described above, other configurations are possible.

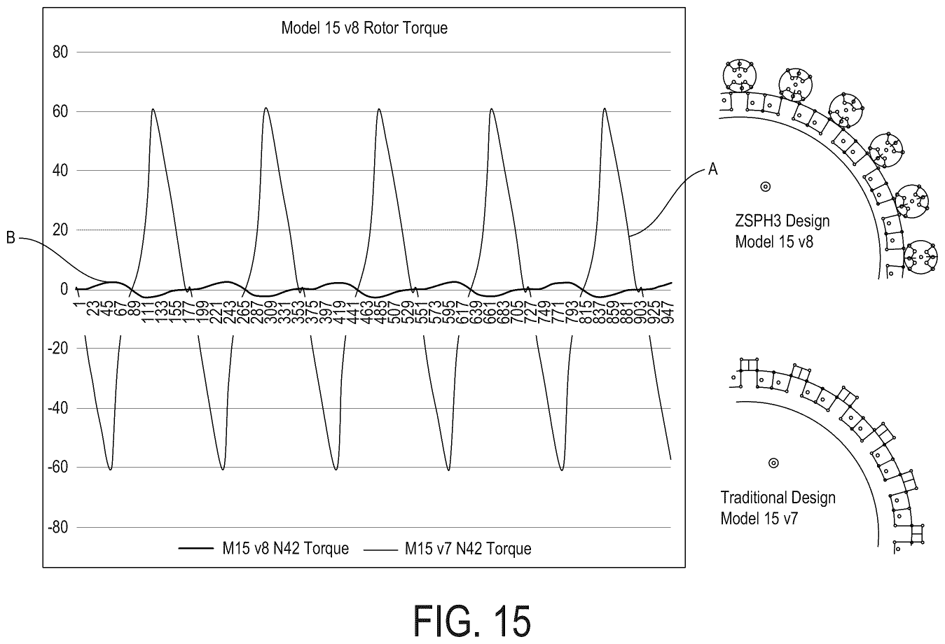

Referring to FIG. 15, the schematic model of FIG. 14 underwent an FEA simulation similar to that described above in relation to FIGS. 7 and 8. A model of a conventional generator with similar dimensions was also created and underwent an FEA simulation to compare the torque requirements of the conventional generator (line A) with those of the schematic model of FIG. 14 with the spinning magnet assemblies (line B). As shown the results reinforce the reduced requirement for input power in the configuration with rotating magnet assemblies compared to a conventional generator.

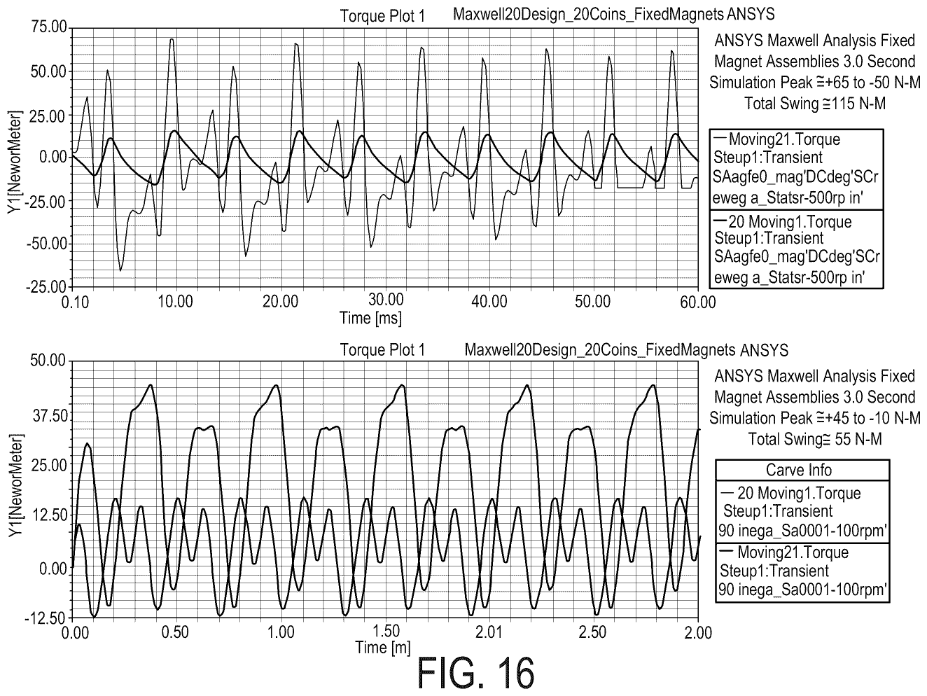

Now referring to FIG. 16, the schematic model of FIG. 14 with spinning magnet assemblies and a model of a conventional generator underwent additional simulations using Ansys Maxwell FEA software. Graph A provides the torque requirements for the conventional model, while Graph B provides the torque requirements for the spinning magnet assembly model. The conventional model, over a 3.0 second simulation, exhibited peaks ≅+65 to −50 N-M and a total swing of ≅115 N-M. The spinning magnet assembly model, over a 3.0 second simulation, exhibited peaks ≅+45 to −10 N-M and a total swing of ≅55 N-M. As illustrated, the torque requirements of the spinning magnet assembly model is about half that of the conventional model.

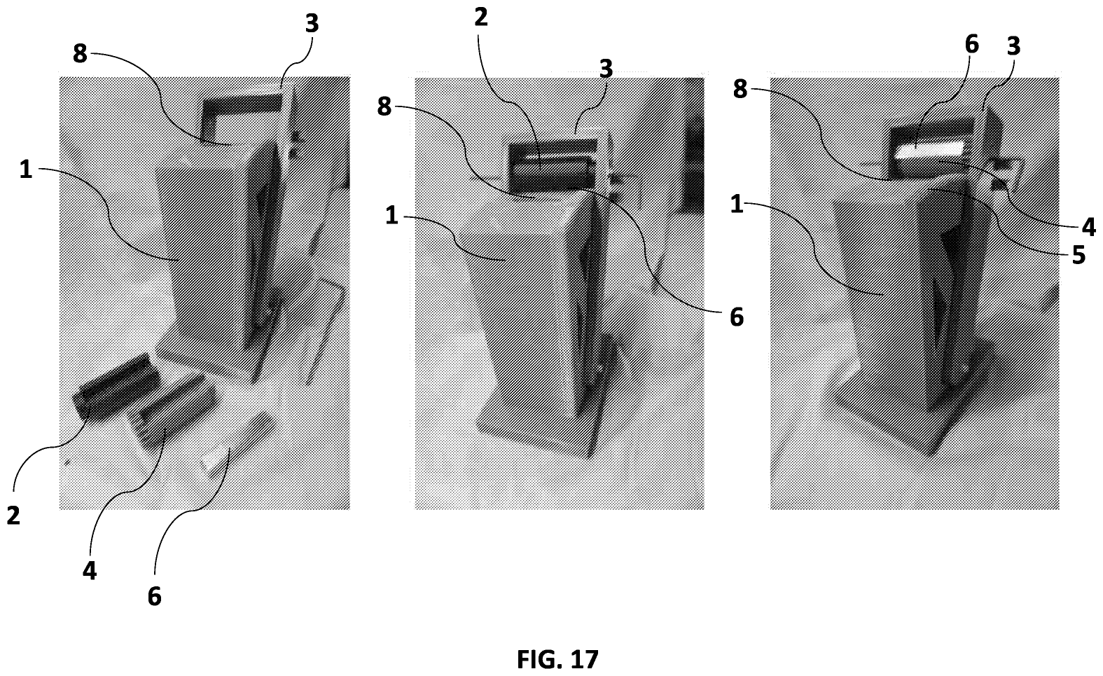

FIG. 17 shows an exemplary single rotor tooth manufactured via additive manufacturing. In the left image, the main body 1 of the rotor tooth is shown assembled with a rotating arm 3. The locked magnet assembly cylinder 2 lacks gear teeth. The spinning magnet assembly 4 includes gear teeth. The magnet 6 is configured to be embedded in either of the locked magnet assembly cylinder 2 or the spinning magnet assembly 4. The opposing polarity magnet 8 is embedded at the top of the main body 1.

The center image of FIG. 17 illustrates the locked magnet assembly cylinder 2 mounted to the rotating arm 3 of the main body 1. The magnet 6 faces downward to pass directly over the opposing polarity magnet 8 to simulate the operation of a conventional generator. Both magnets 6, 8 are oriented with the same pole facing each other so that they resist the motion of the rotating arm 3 when coming in close proximity to one another.

The right image of FIG. 17 illustrates the spinning magnet assembly 4 mounted to the rotating arm 3. There is nothing locking the cylinder 4 in place and it is free to rotate, meshed with gear teeth 5 of the main body 1. The magnets 6, 8 are again oriented with the same pole facing each other so that they resist the motion of the rotating arm 3 when coming in close proximity to one another. A scale was used to measure the amount of force required to pull the rotating arm 3 past the magnet 8 embedded in the main body 1 of the rotor tooth. The center configuration including the locked magnet assembly cylinder 2 required more force to move the rotating arm 3, reinforcing the discussion above. For example, the fixed magnet assembly peak was ≅22.7 lb, while the rotating magnet assembly peak was ≅12.6. As such, the peak force for the fixed magnet assembly required 1.8× more force than that of the rotating magnet assembly.

The following discussion is had without reference to any specific figure but generally to the figures discussed above.

The electric generator utilizes a rotor with multiple inductive teeth, each wrapped with wire to form an inductor. These inductors interact with the alternating polarity magnets in the stator to generate a time-varying voltage output. This interaction leverages electromagnetic induction principles, which are well-understood for converting mechanical energy into electrical energy. By ensuring continuous magnetic flux changes in the rotor teeth, the generator provides consistent energy output. This method aligns with established practices but optimizes efficiency through refined magnetic configurations. The result is reliable performance with minimized mechanical resistance.

The alternating polarity magnets in the stator are positioned to maximize the rotor's exposure to alternating magnetic fields. This design ensures that as the rotor spins, its teeth experience continuous polarity changes. Such a setup enhances the electromagnetic coupling between the rotor and the stator, a concept fundamental to generator designs. The configuration's symmetry reduces energy losses typically associated with uneven magnetic flux distribution. By achieving a uniform induction pattern, the system improves energy output consistency. This approach refines traditional stator-rotor interactions to elevate efficiency.

The use of soft magnetic metal in the rotor teeth facilitates smoother polarity transitions and reduces energy losses due to magnetic hysteresis. This choice of material is grounded in the known properties of soft magnetic alloys, which exhibit high permeability and low coercivity. These properties are essential for minimizing the energy required for magnetization and demagnetization cycles. By incorporating such materials, the generator aligns with established practices while enhancing efficiency. This optimization supports high-frequency operation with minimal heat generation. Consequently, the design improves both performance and durability.

The spacing between the rotor teeth and the stator magnets is optimized to balance magnetic field strength and mechanical resistance. Known magnetic field behavior follows the inverse square law, making precise spacing critical for performance. By reducing the gap, the magnetic flux density increases exponentially, enhancing induction. However, excessive proximity can increase drag forces, counteracting the benefits. The generator achieves an ideal balance, leveraging magnetic principles to maximize energy conversion without unnecessary torque demands. This balance represents a practical refinement of established generator designs.

Redirecting opposing magnetic forces perpendicular to the input torque reduces mechanical resistance and optimizes energy transfer. This concept builds on established magnetic force dynamics, where vector alignment affects efficiency. By channeling resistance forces away from the axis of rotation, the design minimizes direct opposition to rotor motion. This approach reduces energy losses and enhances mechanical efficiency, particularly under high-load conditions. The generator's refinement of force redirection exemplifies an innovative application of these principles. This method supports prolonged operation with reduced wear on components.

The aluminum cylinders with embedded magnets enhance the generator's efficiency by reducing input torque requirements. This configuration uses well-known properties of lightweight metals combined with embedded magnetic materials to create a dynamic interaction with the rotor teeth. Rotating these cylinders in synchronization with the rotor reduces resistance while maintaining magnetic field stability. Such innovations build on existing knowledge but optimize the interaction between magnetic and mechanical components. This refinement allows for smoother energy conversion and better performance under variable load conditions. The design is particularly advantageous for applications requiring high efficiency and low operational costs.

The gear mechanism connecting the rotor and aluminum cylinders ensures precise synchronization, enhancing the generator's performance. By maintaining a fixed rotational ratio, the gears prevent misalignment and ensure uniform energy transfer. This mechanical arrangement is based on well-established principles of gear design and power transmission. The integration of gears into the generator's configuration adds stability and reduces operational vibrations. By achieving consistent interaction between components, the system minimizes energy losses. This approach extends the generator's lifespan and ensures reliable energy output.

The slip rings on the rotor enable real-time electrical activity measurement, offering a direct method to monitor generator performance. Slip rings are commonly used in rotating machinery to provide electrical connectivity, and their integration here aligns with established practices. By capturing real-time data, operators can optimize the generator's efficiency and address any performance deviations promptly. This monitoring capability enhances reliability and supports predictive maintenance. The inclusion of slip rings reflects a thoughtful application of proven technologies to enhance operational oversight. This feature ensures the generator operates within optimal parameters under varying conditions.

The embedding of magnets in the aluminum cylinders at precise intervals ensures consistent magnetic interaction with the rotor teeth. This design builds on the understanding of magnetic field uniformity and its impact on energy conversion. By positioning the magnets strategically, the generator achieves a stable and predictable induction process. This configuration reduces fluctuations in energy output, which are common in less optimized systems. The precise alignment of magnets with rotor teeth enhances the generator's reliability and performance. This arrangement demonstrates a practical improvement over traditional designs.

The generator's ability to reduce input torque requirements while maintaining high energy output represents a significant efficiency gain. This efficiency translates into lower operational costs and broader applicability across energy sectors. By leveraging refined magnetic and mechanical interactions, the design minimizes waste and maximizes performance. This feature aligns with growing demands for sustainable energy solutions. The system's adaptability to different power needs further underscores its practicality. Such advancements provide tangible benefits over less efficient configurations.

The method of generating electricity involves rotating a rotor with inductive teeth through a magnetic field created by alternating polarity magnets. This approach ensures continuous energy generation by maintaining dynamic electromagnetic coupling. The system's design minimizes interruptions in energy flow, which can occur due to uneven magnetic flux distributions. This continuous operation supports stable energy output, even under variable rotational speeds. By refining the core principles of electromagnetic induction, the generator achieves high reliability. This method exemplifies the effective application of well-established energy conversion techniques.

Maintaining consistent spacing between rotor teeth and magnets optimizes the magnetic flux density, a critical factor in generator efficiency. The relationship between magnetic field strength and distance is well-documented, emphasizing the importance of precise alignment. By reducing the gap, the generator achieves higher energy conversion rates without introducing excessive mechanical drag. This careful balance demonstrates a sophisticated understanding of magnetic dynamics. The result is a system that maximizes energy output while minimizing physical resistance. Such precision contributes to the generator's overall efficiency and performance.

Simulations using Finite Element Analysis (FEA) software validate the generator's design and performance. FEA simulations are a proven method for modeling complex systems, allowing for precise predictions of torque requirements and magnetic field interactions. These simulations confirm the system's ability to maintain high energy output with reduced input energy. By identifying potential inefficiencies, the design is optimized for real-world applications. This iterative process ensures the generator meets rigorous performance standards. The use of FEA underscores the system's engineering sophistication and reliability.

Embedding alternating polarity magnets in the stator ensures consistent induction across the rotor's rotation. This design creates a dynamic magnetic environment that supports continuous energy generation. By alternating polarities, the system minimizes magnetic stagnation and ensures efficient energy transfer. This configuration aligns with fundamental electromagnetic principles, enhancing the generator's reliability. Such precision reduces energy losses commonly associated with static magnetic fields. This approach optimizes the generator's performance under varying load conditions.

The conductive path connected to the rotor teeth allows for efficient energy extraction, minimizing resistance during transfer. This design ensures that the electrical output is effectively harnessed and transmitted. By reducing resistive losses, the generator maximizes the usable energy produced. This efficient extraction process aligns with established practices in electrical engineering. The system's ability to deliver consistent energy output supports a wide range of applications. Such a design reflects a thorough understanding of energy transfer dynamics.

The aluminum cylinders' rotational freedom reduces magnetic resistance, enhancing the generator's efficiency. This feature prevents the buildup of opposing magnetic forces that can hinder rotor motion. By allowing the cylinders to rotate, the system minimizes drag and improves energy conversion rates. This innovation refines traditional designs, making the generator more adaptable to varying operational conditions. The result is a system that balances high performance with low mechanical resistance. This efficiency supports broader adoption in energy applications.

The generator's compact design, combined with its efficiency, makes it suitable for diverse applications, from residential to industrial use. Its scalability allows for customization based on specific energy needs. This adaptability reflects a thoughtful approach to design, ensuring the system meets various power demands effectively. The compact nature reduces installation and maintenance challenges, making it accessible to a wider audience. By combining efficiency with versatility, the generator offers a practical solution for modern energy challenges. This design underscores the system's utility and potential.

The embedded magnets' alignment with the rotor teeth ensures optimal interaction, reducing energy losses. This precise alignment supports consistent magnetic coupling, a key factor in reliable energy generation. By minimizing misalignment, the system avoids fluctuations in performance and energy output. This feature demonstrates an advanced application of magnetic field principles to optimize efficiency. Such precision contributes to the generator's overall reliability and durability. The system's performance reflects careful attention to detail in its engineering.

The configuration directing opposing magnetic forces into a perpendicular plane reduces operational resistance and improves energy efficiency. This approach minimizes direct opposition to rotor motion, a common source of energy loss. By channeling these forces away from the axis of rotation, the system achieves smoother operation and lower input energy requirements. This method reflects an innovative application of magnetic dynamics to enhance performance. The generator's ability to operate efficiently under high loads further demonstrates its robustness. Such advancements highlight the system's engineering excellence.

The gear mechanism's precision ensures the rotor and aluminum cylinders operate in harmony, minimizing mechanical stress. This synchronization reduces wear on components, extending the system's lifespan. By achieving a stable and balanced operation, the generator maintains consistent energy output. This feature reflects established principles of mechanical design, applied here to enhance reliability. The reduced stress on moving parts also supports long-term performance. This integration of mechanical precision underscores the system's robust design.

The electric generator utilizes a rotor with multiple inductive teeth, each wrapped with wire to form an inductor. These inductors interact with the alternating polarity magnets in the stator to generate a time-varying voltage output. This interaction leverages electromagnetic induction principles, which are well-understood for converting mechanical energy into electrical energy. By ensuring continuous magnetic flux changes in the rotor teeth, the generator provides consistent energy output. This method aligns with established practices but optimizes efficiency through refined magnetic configurations. The result is reliable performance with minimized mechanical resistance.

The alternating polarity magnets in the stator are positioned to maximize the rotor's exposure to alternating magnetic fields. This design ensures that as the rotor spins, its teeth experience continuous polarity changes. Such a setup enhances the electromagnetic coupling between the rotor and the stator, a concept fundamental to generator designs. The configuration's symmetry reduces energy losses typically associated with uneven magnetic flux distribution. By achieving a uniform induction pattern, the system improves energy output consistency. This approach refines traditional stator-rotor interactions to elevate efficiency.

The use of soft magnetic metal in the rotor teeth facilitates smoother polarity transitions and reduces energy losses due to magnetic hysteresis. This choice of material is grounded in the known properties of soft magnetic alloys, which exhibit high permeability and low coercivity. These properties are essential for minimizing the energy required for magnetization and demagnetization cycles. By incorporating such materials, the generator aligns with established practices while enhancing efficiency. This optimization supports high-frequency operation with minimal heat generation. Consequently, the design improves both performance and durability.

The spacing between the rotor teeth and the stator magnets is optimized to balance magnetic field strength and mechanical resistance. Known magnetic field behavior follows the inverse square law, making precise spacing critical for performance. By reducing the gap, the magnetic flux density increases exponentially, enhancing induction. However, excessive proximity can increase drag forces, counteracting the benefits. The generator achieves an ideal balance, leveraging magnetic principles to maximize energy conversion without unnecessary torque demands. This balance represents a practical refinement of established generator designs.

Redirecting opposing magnetic forces perpendicular to the input torque reduces mechanical resistance and optimizes energy transfer. This concept builds on established magnetic force dynamics, where vector alignment affects efficiency. By channeling resistance forces away from the axis of rotation, the design minimizes direct opposition to rotor motion. This approach reduces energy losses and enhances mechanical efficiency, particularly under high-load conditions. The generator's refinement of force redirection exemplifies an innovative application of these principles. This method supports prolonged operation with reduced wear on components.

The aluminum cylinders with embedded magnets enhance the generator's efficiency by reducing input torque requirements. This configuration uses well-known properties of lightweight metals combined with embedded magnetic materials to create a dynamic interaction with the rotor teeth. Rotating these cylinders in synchronization with the rotor reduces resistance while maintaining magnetic field stability. Such innovations build on existing knowledge but optimize the interaction between magnetic and mechanical components. This refinement allows for smoother energy conversion and better performance under variable load conditions. The design is particularly advantageous for applications requiring high efficiency and low operational costs.

The gear mechanism connecting the rotor and aluminum cylinders ensures precise synchronization, enhancing the generator's performance. By maintaining a fixed rotational ratio, the gears prevent misalignment and ensure uniform energy transfer. This mechanical arrangement is based on well-established principles of gear design and power transmission. The integration of gears into the generator's configuration adds stability and reduces operational vibrations. By achieving consistent interaction between components, the system minimizes energy losses. This approach extends the generator's lifespan and ensures reliable energy output.

The slip rings on the rotor enabled real-time electrical activity measurement, offering a direct method to monitor generator performance. Slip rings are commonly used in rotating machinery to provide electrical connectivity, and their integration here aligns with established practices. By capturing real-time data, operators can optimize the generator's efficiency and address any performance deviations promptly. This monitoring capability enhances reliability and supports predictive maintenance. The inclusion of slip rings reflects a thoughtful application of proven technologies to enhance operational oversight. This feature ensures the generator operates within optimal parameters under varying conditions.

The embedding of magnets in the aluminum cylinders at precise intervals ensures consistent magnetic interaction with the rotor teeth. This design builds on the understanding of magnetic field uniformity and its impact on energy conversion. By positioning the magnets strategically, the generator achieves a stable and predictable induction process. This configuration reduces fluctuations in energy output, which are common in less optimized systems. The precise alignment of magnets with rotor teeth enhances the generator's reliability and performance. This arrangement demonstrates a practical improvement over traditional designs.

The generator's ability to reduce input torque requirements while maintaining high energy output represents a significant efficiency gain. This efficiency translates into lower operational costs and broader applicability across energy sectors. By leveraging refined magnetic and mechanical interactions, the design minimizes waste and maximizes performance. This feature aligns with growing demands for sustainable energy solutions. The system's adaptability to different power needs further underscores its practicality. Such advancements provide tangible benefits over less efficient configurations.

The method of generating electricity involves rotating a rotor with inductive teeth through a magnetic field created by alternating polarity magnets. This approach ensures continuous energy generation by maintaining dynamic electromagnetic coupling. The system's design minimizes interruptions in energy flow, which can occur due to uneven magnetic flux distributions. This continuous operation supports stable energy output, even under variable rotational speeds. By refining the core principles of electromagnetic induction, the generator achieves high reliability. This method exemplifies the effective application of well-established energy conversion techniques.

Maintaining consistent spacing between rotor teeth and magnets optimizes the magnetic flux density, a critical factor in generator efficiency. The relationship between magnetic field strength and distance is well-documented, emphasizing the importance of precise alignment. By reducing the gap, the generator achieves higher energy conversion rates without introducing excessive mechanical drag. This careful balance demonstrates a sophisticated understanding of magnetic dynamics. The result is a system that maximizes energy output while minimizing physical resistance. Such precision contributes to the generator's overall efficiency and performance.

Simulations using Finite Element Analysis (FEA) software validate the generator's design and performance. FEA simulations are a proven method for modeling complex systems, allowing for precise predictions of torque requirements and magnetic field interactions. These simulations confirm the system's ability to maintain high energy output with reduced input energy. By identifying potential inefficiencies, the design is optimized for real-world applications. This iterative process ensures the generator meets rigorous performance standards. The use of FEA underscores the system's engineering sophistication and reliability.

Embedding alternating polarity magnets in the stator ensures consistent induction across the rotor's rotation. This design creates a dynamic magnetic environment that supports continuous energy generation. By alternating polarities, the system minimizes magnetic stagnation and ensures efficient energy transfer. This configuration aligns with fundamental electromagnetic principles, enhancing the generator's reliability. Such precision reduces energy losses commonly associated with static magnetic fields. This approach optimizes the generator's performance under varying load conditions.

The conductive path connected to the rotor teeth allows for efficient energy extraction, minimizing resistance during transfer. This design ensures that the electrical output is effectively harnessed and transmitted. By reducing resistive losses, the generator maximizes the usable energy produced. This efficient extraction process aligns with established practices in electrical engineering. The system's ability to deliver consistent energy output supports a wide range of applications. Such a design reflects a thorough understanding of energy transfer dynamics.

The aluminum cylinders' rotational freedom reduces magnetic resistance, enhancing the generator's efficiency. This feature prevents the buildup of opposing magnetic forces that can hinder rotor motion. By allowing the cylinders to rotate, the system minimizes drag and improves energy conversion rates. This innovation refines traditional designs, making the generator more adaptable to varying operational conditions. The result is a system that balances high performance with low mechanical resistance. This efficiency supports broader adoption in energy applications.

The generator's compact design, combined with its efficiency, makes it suitable for diverse applications, from residential to industrial use. Its scalability allows for customization based on specific energy needs. This adaptability reflects a thoughtful approach to design, ensuring the system meets various power demands effectively. The compact nature reduces installation and maintenance challenges, making it accessible to a wider audience. By combining efficiency with versatility, the generator offers a practical solution for modern energy challenges. This design underscores the system's utility and potential.

The embedded magnets' alignment with the rotor teeth ensures optimal interaction, reducing energy losses. This precise alignment supports consistent magnetic coupling, a key factor in reliable energy generation. By minimizing misalignment, the system avoids fluctuations in performance and energy output. This feature demonstrates an advanced application of magnetic field principles to optimize efficiency. Such precision contributes to the generator's overall reliability and durability. The system's performance reflects careful attention to detail in its engineering.

The configuration directing opposing magnetic forces into a perpendicular plane reduces operational resistance and improves energy efficiency. This approach minimizes direct opposition to rotor motion, a common source of energy loss. By channeling these forces away from the axis of rotation, the system achieves smoother operation and lower input energy requirements. This method reflects an innovative application of magnetic dynamics to enhance performance. The generator's ability to operate efficiently under high loads further demonstrates its robustness. Such advancements highlight the system's engineering excellence.

The gear mechanism's precision ensures the rotor and aluminum cylinders operate in harmony, minimizing mechanical stress. This synchronization reduces wear on components, extending the system's lifespan. By achieving a stable and balanced operation, the generator maintains consistent energy output. This feature reflects established principles of mechanical design, applied here to enhance reliability. The reduced stress on moving parts also supports long-term performance. This integration of mechanical precision underscores the system's robust design.

The electric generator utilizes a rotor with multiple inductive teeth, each wrapped with wire to form an inductor. These inductors interact with the alternating polarity magnets in the stator to generate a time-varying voltage output. This interaction leverages electromagnetic induction principles, which are well-understood for converting mechanical energy into electrical energy. By ensuring continuous magnetic flux changes in the rotor teeth, the generator provides consistent energy output. This method aligns with established practices but optimizes efficiency through refined magnetic configurations. The result is reliable performance with minimized mechanical resistance.

The alternating polarity magnets in the stator are positioned to maximize the rotor's exposure to alternating magnetic fields. This design ensures that as the rotor spins, its teeth experience continuous polarity changes. Such a setup enhances the electromagnetic coupling between the rotor and the stator, a concept fundamental to generator designs. The configuration's symmetry reduces energy losses typically associated with uneven magnetic flux distribution. By achieving a uniform induction pattern, the system improves energy output consistency. This approach refines traditional stator-rotor interactions to elevate efficiency.

The use of soft magnetic metal in the rotor teeth facilitates smoother polarity transitions and reduces energy losses due to magnetic hysteresis. This choice of material is grounded in the known properties of soft magnetic alloys, which exhibit high permeability and low coercivity. These properties are essential for minimizing the energy required for magnetization and demagnetization cycles. By incorporating such materials, the generator aligns with established practices while enhancing efficiency. This optimization supports high-frequency operation with minimal heat generation. Consequently, the design improves both performance and durability.

The spacing between the rotor teeth and the stator magnets is optimized to balance magnetic field strength and mechanical resistance. Known magnetic field behavior follows the inverse square law, making precise spacing critical for performance. By reducing the gap, the magnetic flux density increases exponentially, enhancing induction. However, excessive proximity can increase drag forces, counteracting the benefits. The generator achieves an ideal balance, leveraging magnetic principles to maximize energy conversion without unnecessary torque demands. This balance represents a practical refinement of established generator designs.

Redirecting opposing magnetic forces perpendicular to the input torque reduces mechanical resistance and optimizes energy transfer. This concept builds on established magnetic force dynamics, where vector alignment affects efficiency. By channeling resistance forces away from the axis of rotation, the design minimizes direct opposition to rotor motion. This approach reduces energy losses and enhances mechanical efficiency, particularly under high-load conditions. The generator's refinement of force redirection exemplifies an innovative application of these principles. This method supports prolonged operation with reduced wear on components.

The aluminum cylinders with embedded magnets enhance the generator's efficiency by reducing input torque requirements. This configuration uses well-known properties of lightweight metals combined with embedded magnetic materials to create a dynamic interaction with the rotor teeth. Rotating these cylinders in synchronization with the rotor reduces resistance while maintaining magnetic field stability. Such innovations build on existing knowledge but optimize the interaction between magnetic and mechanical components. This refinement allows for smoother energy conversion and better performance under variable load conditions. The design is particularly advantageous for applications requiring high efficiency and low operational costs.

The gear mechanism connecting the rotor and aluminum cylinders ensures precise synchronization, enhancing the generator's performance. By maintaining a fixed rotational ratio, the gears prevent misalignment and ensure uniform energy transfer. This mechanical arrangement is based on well-established principles of gear design and power transmission. The integration of gears into the generator's configuration adds stability and reduces operational vibrations. By achieving consistent interaction between components, the system minimizes energy losses. This approach extends the generator's lifespan and ensures reliable energy output.

The slip rings on the rotor enables real-time electrical activity measurements, offering a direct method to monitor generator performance. Slip rings are commonly used in rotating machinery to provide electrical connectivity, and their integration here aligns with established practices. By capturing real-time data, operators can optimize the generator's efficiency and address any performance deviations promptly. This monitoring capability enhances reliability and supports predictive maintenance. The inclusion of slip rings reflects a thoughtful application of proven technologies to enhance operational oversight. This feature ensures the generator operates within optimal parameters under varying conditions.

The embedding of magnets in the aluminum cylinders at precise intervals ensures consistent magnetic interaction with the rotor teeth. This design builds on the understanding of magnetic field uniformity and its impact on energy conversion. By positioning the magnets strategically, the generator achieves a stable and predictable induction process. This configuration reduces fluctuations in energy output, which are common in less optimized systems. The precise alignment of magnets with rotor teeth enhances the generator's reliability and performance. This arrangement demonstrates a practical improvement over traditional designs.

The generator's ability to reduce input torque requirements while maintaining high energy output represents a significant efficiency gain. This efficiency translates into lower operational costs and broader applicability across energy sectors. By leveraging refined magnetic and mechanical interactions, the design minimizes waste and maximizes performance. This feature aligns with growing demands for sustainable energy solutions. The system's adaptability to different power needs further underscores its practicality. Such advancements provide tangible benefits over less efficient configurations.

The method of generating electricity involves rotating a rotor with inductive teeth through a magnetic field created by alternating polarity magnets. This approach ensures continuous energy generation by maintaining dynamic electromagnetic coupling. The system's design minimizes interruptions in energy flow, which can occur due to uneven magnetic flux distributions. This continuous operation supports stable energy output, even under variable rotational speeds. By refining the core principles of electromagnetic induction, the generator achieves high reliability. This method exemplifies the effective application of well-established energy conversion techniques.

Maintaining consistent spacing between rotor teeth and magnets optimizes the magnetic flux density, a critical factor in generator efficiency. The relationship between magnetic field strength and distance is well-documented, emphasizing the importance of precise alignment. By reducing the gap, the generator achieves higher energy conversion rates without introducing excessive mechanical drag. This careful balance demonstrates a sophisticated understanding of magnetic dynamics. The result is a system that maximizes energy output while minimizing physical resistance. Such precision contributes to the generator's overall efficiency and performance.

Simulations using Finite Element Analysis (FEA) software validate the generator's design and performance. FEA simulations are a proven method for modeling complex systems, allowing for precise predictions of torque requirements and magnetic field interactions. These simulations confirm the system's ability to maintain high energy output with reduced input energy. By identifying potential inefficiencies, the design is optimized for real-world applications. This iterative process ensures the generator meets rigorous performance standards. The use of FEA underscores the system's engineering sophistication and reliability.

Embedding alternating polarity magnets in the stator ensures consistent induction across the rotor's rotation. This design creates a dynamic magnetic environment that supports continuous energy generation. By alternating polarities, the system minimizes magnetic stagnation and ensures efficient energy transfer. This configuration aligns with fundamental electromagnetic principles, enhancing the generator's reliability. Such precision reduces energy losses commonly associated with static magnetic fields. This approach optimizes the generator's performance under varying load conditions.

The conductive path connected to the rotor teeth allows for efficient energy extraction, minimizing resistance during transfer. This design ensures that the electrical output is effectively harnessed and transmitted. By reducing resistive losses, the generator maximizes the usable energy produced. This efficient extraction process aligns with established practices in electrical engineering. The system's ability to deliver consistent energy output supports a wide range of applications. Such a design reflects a thorough understanding of energy transfer dynamics.

The aluminum cylinders' rotational freedom reduces magnetic resistance, enhancing the generator's efficiency. This feature prevents the buildup of opposing magnetic forces that can hinder rotor motion. By allowing the cylinders to rotate, the system minimizes drag and improves energy conversion rates. This innovation refines traditional designs, making the generator more adaptable to varying operational conditions. The result is a system that balances high performance with low mechanical resistance. This efficiency supports broader adoption in energy applications.

The generator's compact design, combined with its efficiency, makes it suitable for diverse applications, from residential to industrial use. Its scalability allows for customization based on specific energy needs. This adaptability reflects a thoughtful approach to design, ensuring the system meets various power demands effectively. The compact nature reduces installation and maintenance challenges, making it accessible to a wider audience. By combining efficiency with versatility, the generator offers a practical solution for modern energy challenges. This design underscores the system's utility and potential.

The embedded magnets' alignment with the rotor teeth ensures optimal interaction, reducing energy losses. This precise alignment supports consistent magnetic coupling, a key factor in reliable energy generation. By minimizing misalignment, the system avoids fluctuations in performance and energy output. This feature demonstrates an advanced application of magnetic field principles to optimize efficiency. Such precision contributes to the generator's overall reliability and durability. The system's performance reflects careful attention to detail in its engineering.

The configuration directing opposing magnetic forces into a perpendicular plane reduces operational resistance and improves energy efficiency. This approach minimizes direct opposition to rotor motion, a common source of energy loss. By channeling these forces away from the axis of rotation, the system achieves smoother operation and lower input energy requirements. This method reflects an innovative application of magnetic dynamics to enhance performance. The generator's ability to operate efficiently under high loads further demonstrates its robustness. Such advancements highlight the system's engineering excellence.

The gear mechanism's precision ensures the rotor and aluminum cylinders operate in harmony, minimizing mechanical stress. This synchronization reduces wear on components, extending the system's lifespan. By achieving a stable and balanced operation, the generator maintains consistent energy output. This feature reflects established principles of mechanical design, applied here to enhance reliability. The reduced stress on moving parts also supports long-term performance. This integration of mechanical precision underscores the system's robust design.

The generator's ability to minimize energy waste while maintaining output efficiency supports a wide array of industrial applications, such as manufacturing processes requiring consistent power. For residential use, its compact form factor and operational efficiency make it an ideal candidate for backup power systems and renewable energy setups. By offering scalability, the generator accommodates diverse energy demands, from small-scale home applications to large-scale commercial operations. Its case of installation and low maintenance requirements further enhance its appeal across sectors. This versatility ensures the generator remains a practical and valuable solution for a variety of energy needs.

The system's enhanced magnetic coupling contributes to reduced torque requirements, making it compatible with a range of driving mechanisms, including low-power motors. This compatibility broadens its potential use cases, enabling integration with wind turbines, water turbines, or even manual cranks in remote applications. By reducing mechanical resistance, the generator also extends the lifespan of connected equipment, decreasing overall system costs. These benefits highlight its adaptability to both traditional and alternative energy systems. This ability to integrate seamlessly with diverse setups underscores its practical design and efficiency.

The rotor's inductive teeth, combined with the stator's alternating polarity magnets, ensure a consistent and reliable energy output. This predictability is particularly beneficial in environments where power stability is critical, such as medical facilities or data centers. The generator's robust design allows it to maintain operation under fluctuating load conditions, ensuring uninterrupted power supply. This resilience is supported by its efficient heat dissipation, which prevents overheating during extended use. These qualities make the generator a dependable choice for both critical infrastructure and general energy applications.

The aluminum cylinders' design ensures smooth operation even in high-demand scenarios. By reducing drag and magnetic resistance, these components enable the generator to maintain performance without requiring excessive input energy. This efficiency is particularly advantageous in renewable energy systems, where consistent performance is essential despite variable input conditions, such as changing wind or water flow rates. The generator's ability to adapt to these conditions while maintaining output efficiency highlights its suitability for sustainable energy projects. This adaptability supports its integration into evolving energy infrastructures.

The embedded magnets' precise alignment with the rotor teeth enhances the system's overall efficiency. This configuration reduces magnetic flux leakage, ensuring that the maximum possible energy is converted and harnessed. Such optimization minimizes energy losses commonly seen in less advanced systems, providing a higher return on energy investment. The resulting improvements in efficiency and output make the generator ideal for applications where energy conservation is a priority. This focus on optimized performance reflects a forward-thinking approach to energy system design.

The generator's low operational noise makes it suitable for residential and urban environments where noise pollution is a concern. Its quiet performance ensures that it can be used in close proximity to living spaces without causing disruptions. Additionally, the system's vibration damping mechanisms enhance its stability and further reduce noise. These features increase the generator's appeal for use in noise-sensitive areas, such as schools, hospitals, and residential neighborhoods. This thoughtful consideration of operational impact demonstrates the generator's user-centric design.

The following are nonlimiting practical examples of implementations based on this disclosure. They should be understood as just that—examples—and only some of the many examples disclosed herein.

In Example 1,an electric generator comprising: a rotor having a plurality of rotor teeth, each rotor tooth comprising a magnetic metal core wrapped with wire to form an inductor; a stator comprising a plurality of magnets, each magnet having an alternating polarity relative to adjacent magnets, arranged around at least a portion of the rotor's perimeter; and a configuration wherein the rotor rotates within the magnetic field created by the stator, inducing alternating polarity in the rotor teeth as they pass the magnets, thereby generating an electrical output.

In Example 2, the electric generator as Example 1 describes, wherein the rotor teeth are configured with a soft magnetic metal to enhance polarity transition efficiency.

In Example 3, the electric generator as either of Examples 1 or 2 describe, wherein the stator includes a single permanent magnet surrounded by additional magnets of alternating polarity.

In Example 4, the electric generator as any of Examples 1-3 describe, wherein the spacing between the rotor teeth and the stator magnets is optimized to maximize magnetic field strength.

In Example 5, the electric generator as any of Examples 1-4 describe, further comprising a mechanism for redirecting opposing magnetic forces perpendicular to the input torque direction.

In Example 6, the electric generator as any of Examples 1-5 describe, further comprising a configuration for rotating magnet assemblies around the rotor to reduce input torque requirements.

In Example 7, the electric generator as any of Examples 1-6 describe, wherein the rotor teeth include an embedded opposing polarity magnet to reduce magnetic resistance.

In Example 8, a system for generating electricity, comprising: a central rotor comprising rotor teeth, each rotor tooth being an inductor; at least two opposing assemblies positioned on either side of the rotor, each assembly comprising: a plurality of magnets embedded within an aluminum cylinder and an iron core separating the magnets; a gear mechanism configured to rotate the rotor and the aluminum cylinders in opposite directions at a 1:1 ratio; and an extractor for extracting electrical energy generated by the rotor teeth as they interact with the magnetic field of the assemblies.

In Example 9, the system as Example 8 describes, wherein the aluminum cylinders rotate in synchronization with the rotor to reduce input torque requirements.

In Example 10, the system as either of Examples 8 or 9 describe, wherein the aluminum cylinders and the rotor are meshed with gears to achieve a 1:1 rotational ratio.

In Example 11, the system as any of Examples 8-10 describe, further comprising slip rings positioned on the rotor for measuring electrical activity.

In Example 12, the system as any of Examples 8-11 describe, wherein the magnets embedded in the aluminum cylinders are configured to align with the rotor teeth during operation.

In Example 13, the system as any of Examples 8-12 describe, wherein the aluminum cylinders are designed to allow for free rotation during operation to reduce resistance.

In Example 14, the system as any of Examples 8-13 describe, further comprising an oscilloscope for real-time monitoring of electrical output.

In Example 15, a method of generating electricity, comprising: rotating a rotor comprising a plurality of rotor teeth within a magnetic field created by a stator comprising a plurality of magnets arranged in alternating polarity; inducing alternating magnetic polarity in the rotor teeth as they pass by the magnets; extracting electrical energy generated by the inductive properties of the rotor teeth; and directing opposing magnetic forces in a perpendicular direction to the input torque to reduce the energy required for rotor rotation while maintaining electrical energy output.

In Example 16, the method as Example 15 describes, wherein the rotor and stator are configured to reduce magnetic resistance by redirecting opposing forces into a perpendicular plane.

In Example 17, the method as either of Examples 15 or 16 describe, further comprising maintaining a consistent distance between the rotor teeth and the magnets to optimize energy efficiency.

In Example 18, the method as any of Examples 15-17 describe, wherein the rotor and stator components are simulated in a Finite Element Analysis (FEA) program to calculate torque requirements.

In Example 19, the method as any of Examples 15-18 describe, further comprising embedding magnets of alternating polarity in the stator to enhance power generation efficiency.

In Example 20, the method as any of Examples 15-19 describe, wherein the generated electrical energy is extracted via a conductive path connected to the rotor teeth.

While the system and methods herein have been described by reference to various specific embodiments it should be understood that numerous changes may be made within the spirit and scope of the concepts described, accordingly, it is intended that the invention is not limited to the described embodiments but will have full scope defined by the language of the following claims.

What is claimed is:

1. An electric generator comprising:
a rotor having a plurality of rotor teeth, each rotor tooth comprising a magnetic metal core wrapped with wire to form an inductor;
a stator comprising a plurality of magnets, each magnet having an alternating polarity relative to adjacent magnets, arranged around at least a portion of the rotor's perimeter; and
a configuration wherein the rotor rotates within the magnetic field created by the stator, inducing alternating polarity in the rotor teeth as they pass the magnets, thereby generating an electrical output.

2. The electric generator of claim 1, wherein the rotor teeth are configured with a soft magnetic metal to enhance polarity transition efficiency.

3. The electric generator of claim 1, wherein the stator includes a single permanent magnet surrounded by additional magnets of alternating polarity.

4. The electric generator of claim 1, wherein the spacing between the rotor teeth and the stator magnets is optimized to maximize magnetic field strength.

5. The electric generator of claim 1, further comprising a mechanism for redirecting opposing magnetic forces perpendicular to the input torque direction.

6. The electric generator of claim 1, further comprising a configuration for rotating magnet assemblies around the rotor to reduce input torque requirements.

7. The electric generator of claim 1, wherein the rotor teeth include an embedded opposing polarity magnet to reduce magnetic resistance.

8. A system for generating electricity, comprising:
a central rotor comprising rotor teeth, each rotor tooth being an inductor;
at least two opposing assemblies positioned on either side of the rotor, each assembly comprising: a plurality of magnets embedded within an aluminum cylinder and an iron core separating the magnets;
a gear mechanism configured to rotate the rotor and the aluminum cylinders in opposite directions at a 1:1 ratio; and
an extractor for extracting electrical energy generated by the rotor teeth as they interact with the magnetic field of the assemblies.

9. The system of claim 8, wherein the aluminum cylinders rotate in synchronization with the rotor to reduce input torque requirements.

10. The system of claim 8, wherein the aluminum cylinders and the rotor are meshed with gears to achieve a 1:1 rotational ratio.

11. The system of claim 8, further comprising slip rings positioned on the rotor for measuring electrical activity.

12. The system of claim 8, wherein the magnets embedded in the aluminum cylinders are configured to align with the rotor teeth during operation.

13. The system of claim 8, wherein the aluminum cylinders are designed to allow for free rotation during operation to reduce resistance.

14. The system of claim 8, further comprising an oscilloscope for real-time monitoring of electrical output.

15. A method of generating electricity, comprising:
rotating a rotor comprising a plurality of rotor teeth within a magnetic field created by a stator comprising a plurality of magnets arranged in alternating polarity;
inducing alternating magnetic polarity in the rotor teeth as they pass by the magnets;
extracting electrical energy generated by the inductive properties of the rotor teeth; and
directing opposing magnetic forces in a perpendicular direction to the input torque to reduce the energy required for rotor rotation while maintaining electrical energy output.

16. The method of claim 15, wherein the rotor and stator are configured to reduce magnetic resistance by redirecting opposing forces into a perpendicular plane.

17. The method of claim 15, further comprising maintaining a consistent distance between the rotor teeth and the magnets to optimize energy efficiency.

18. The method of claim 15, wherein the rotor and stator components are simulated in a Finite Element Analysis (FEA) program to calculate torque requirements.

19. The method of claim 15, further comprising embedding magnets of alternating polarity in the stator to enhance power generation efficiency.

20. The method of claim 15, wherein the generated electrical energy is extracted via a conductive path connected to the rotor teeth.
